(19) United States
(12) Patent Application Publication
(10) Pub. No.: US 2004/0182055 A1
(43) Pub. Date: Sep. 23, 2004

(54) Disposable expandable air filter

(75) Inventor: Gerald M. Wynn, Sanford, NC (US)

Correspondence Address: WELSH & KATZ, LTD, 120 S RIVERSIDE PLAZA, 22ND FLOOR, CHICAGO, IL, 60606, US

(73) Assignee: Fedders Corporation, Liberty Corner, NJ

(21) Appl. No.: 10/767,148

(22) Filed: Jan. 29, 2004

Related U.S. Application Data
(60) Provisional application No. 60/451,464, filed on Mar. 3, 2003.

(51) Int. Cl. B01D 46/00

(52) U.S. Cl. 55/497; 55/499; 55/501

(57) ABSTRACT

A collapsible expandable air filter assembly includes an expandable pleated filter media, a filter frame made from a cardboard blank that is pre-scored, slit, creased and die cut to define a central area enabling air passage therethrough, and side and end panels foldable to positions generally normal to the central area to form a perimeter wall about the central area to receive and support the expanded air filter media. A filter grill is formed from a cardboard blank and has an open central area and laterally opposite marginal side and end walls foldable to enable mounting on the filter frame to assist in retaining the filter media within the filter frame. Separating fingers are formed integral with or separate from but connectable to the filter grill and are adopted to be positioned between adjacent expandable pleats to evenly position and secure the filter pleats. The filter frame and filter grill are foldable into compact folded positions of substantially similar size to the collapsed pleated air filter media to enable compact stacking and insertion into a carton for shipping and storage as a kit before assembly. Alternative collapsible disposable air filter embodiments utilize similar expandable pleated filter media but employ filter frames formed from pairs of panel frame members adapted to have their free ends interconnected to form a rectangular frame that receives the expanded filter media, but can be collapsed for stacking with the collapsed pleated filter media and inserted into a carton for shipping and storage as a kit prior to assembly.

### FIELD OF THE INVENTION

This application claims the benefit of U.S. Provisional Application No. 60/451,464, filed Mar. 3, 2003, and relates generally to replacement media air filters used in duct mounted air cleaners in residential applications, and more particularly to totally disposable expandable air filters.

### BACKGROUND OF THE INVENTION

It is a common practice to filter air that passes through residential forced air type heating and cooling systems. The most common type filter uses a non-woven mesh material retained in a rigid housing constructed of paper, metal, or plastic materials. Typically the filter is installed in a metal cabinet associated with the air mover or blower in a forced air system. The filter cabinet may be placed anywhere within the air moving system but is usually installed in an accessible location in the system so that the filter may be periodically replaced when dirty. Access is typically through a removable panel or service door.

The most common replacement air filters are cartridge type filters employing a multiple pleated filter material restrained within a generally rectangular lightweight cardboard frame, sized to fit the cabinet into which it will be installed. This type of filter requires a large volume of space during shipping and storage before reaching the ultimate consumers.

Other replacement filters utilize permanent metal or plastic filter frame components that accept replacement filter media material. The replacement filter material may be folded or accordioned into a compact package that is then expanded and assembled into the permanent filter frame. A significant disadvantage in this type of replacement filter is that the old filter assembly must be removed from the system. The filter material, which would then be extremely dirty, has to be removed from the permanent frame and discarded. The permanent components that are retained, such as the permanent frame, generally require cleaning before the new replacement filter material is assembled into the frame and reinserted into the system. Thus, a filter assembly that enables compact packaging and is totally disposable would provide significant economic and convenience advantages over the known prior filter assemblies.

### BRIEF SUMMARY OF THE INVENTION

Accordingly, a primary object of the present invention is to provide a filter assembly that enables compact packaging to economize on shipping and storage space, that is expandable into a fully functional air filter assembly that fits the space of a full size filter, and that is totally disposable after use, thereby eliminating the need for messy disassembly of a dirty used filter and cleaning of the permanent components before replacement of the filter media material.

A more particular object of a presently preferred embodiment of the present invention is to provide a disposable expandable air filter employing compactly foldable filter frame components and having integral or separate accordioned expandable filter media material that are adapted to be compactly folded for shipment and storage and later unfolded, expanded and assembled into a filter unit that fits a full size filter media cabinet and that is totally disposable when dirty.

A feature of the air filter in accordance with the present invention lies in providing selectively positioned slots and tabs in the filter frame components for attaching and retaining mating frame components in assembled relation.

Another feature of the air filter in accordance with the present invention lies providing a filter media support frame that is formed from a blank of cardboard and can be folded back upon itself so that it can be secured in compact stacked relation with a collapsed pleated filter media for shipment and storage prior to being expanded and assembled into a full size air filter.

Yet another feature of the air filter in accordance with the present invention lies in the provision of a plurality of spacer or separating fingers that are preferably formed integral with a filter frame grill and are operative to maintain the expanded pleated filter material in its expanded pleated position when the grill is attached to a filter support frame that receives the filter medial material. Alternatively, the filter-locating fingers may be separate from the filter frame grill.

In accordance with the an alternative embodiment of a disposable expandable air filter assembly in accordance with the present invention, a filter frame is provided that includes a pair of primary frame components or two separate pairs of frame components formed from a cardboard or “beverage board” blank that is scored, slit, creased and die cut so that each frame component can comprise two sections or panels that can be stacked in generally flat juxtaposed relation during shipment and storage and subsequently interconnected to form a rectangular filter frame. The free ends of the frame components are joined by tongue and slot locking latch arrangements. The frame components are partially slit or scored adjacent their longitudinal marginal edges to enable forming into a generally rigid structural channel shape so that the assembled frame can receive and support an expanded pleated filter material having opposite end panels attached to selected ones of the frame panel surfaces. In its collapsed condition for shipment and pre-sale storage, the accordioned filter material is collapsed and sandwiched between or with the stacked frame components. Separating fingers used to stabilize the expanded filter pleats after final assembly may be made as individual components that attach to the frame during assembly, or may be formed integral with a support frame component.

### BRIEF DESCRIPTION OF THE DRAWINGS

FIG. 1 is a perspective view of a conventional media air filter support housing with an air filter constructed in accordance with a presently preferred embodiment of the present invention partially inserted into the support housing;

FIG. 2 is a perspective view illustrating the various components of the air filter of FIG. 1 in compactly folded or partially folded positions preparatory to insertion into a carton for shipment and storage before assembly;

FIG. 3 is perspective view illustrating the pleated filter material in its expanded position and having a metal mesh support grid attached to the backside of the pleated filter material;

FIG. 3A is a detail view, on an enlarged scale, illustrating a fragmentary portion of the metal mesh support grid utilized in the expanded filter of FIG. 3;

FIG. 4 is a plan view of a corrugated cardboard blank having slits, score lines and fold lines that enable folding into a filter frame as illustrated in FIG. 7;

FIG. 5 is a plan view of the blank of FIG. 4 but partially folded preparatory to folding of the blank into the compact condition as shown in FIG. 6 for shipment and storage preparatory to assembly into the filter frame of FIG. 7;

FIG. 6 is a perspective view of the filter frame blank of FIG. 5 folded into a compact condition for insertion into a carton as shown in FIG. 2;

FIG. 7 is perspective view illustrating the manner of folding the filter frame blank of FIG. 4 into a rectangular filter frame;

FIG. 8 is a plan view of a corrugated cardboard blank that has been pre-cut and in which score lines and fold lines are formed to facilitate folding into a rectangular grill that is mutually cooperable with the filter frame of FIG. 7 to receive the expanded filter media of FIG. 3;

FIG. 9 is a perspective view showing the filter grill blank of FIG. 8 folded into a compact position preparatory to insertion into the compact carton as illustrated in FIG. 2;

FIG. 10 is a perspective view illustrating the manner of assembling the filter grill onto the filter frame with the expanded filter of FIG. 3 disposed within the filter frame;

FIG. 11 is a perspective view illustrating the filter grill of FIG. 8 assembled onto the filter frame with the expanded filter media housed within the filter frame to complete the air filter illustrated in FIG. 1;

FIG. 12 is a perspective view illustrating an alternative embodiment of a disposable air filter made in accordance with the present invention;

FIG. 13 is a plan view of a blank of “beverage board” or small fluted corrugated cardboard that is pre-scored, slit, creased and die cut and from which two primary components of a rectangular filter frame are formed along with strips of separating fingers utilized to stabilize the filter pleats during final assembly of the filter illustrated in FIG. 12;

FIG. 14 is a perspective view showing the primary components of the filter frame employed in the filter of FIG. 12, each frame component having two panels adapted to be transversely folded in juxtaposed relation and having a pre-pleated accordioned filter material interposed between and secured to selected ones of the frame panels;

FIG. 15 is a perspective view showing the pleated filter material of FIG. 14 collapsed between the folded frame components;

FIG. 16 is a perspective view illustrating the various components of the air filter of FIG. 12 collapsed and bundled for shipment and storage;

FIG. 17 is a perspective view illustrating a panel of each filter frame component of FIG. 14 being unfolded to create a substantially rectangular frame with the expanded pleated filter media having end panels secured to selected ones of the frame panels so as to lie within the assembled filter frame;

FIG. 18 is a fragmentary perspective view illustrating the manner of interconnecting the mutually opposed free ends of the filter frame components of FIG. 17 to create a rectangular filter frame;

FIG. 19 is a perspective view showing the two primary frame components of FIG. 18 interconnected at diagonally opposite corners with the pleated filter media interposed between opposite panels of the frame components;

FIG. 20 is a perspective view similar to FIG. 19 but having a representative row of separating fingers partially inserted between adjacent expanded filter media pleats;

FIG. 21 is a fragmentary view, on an enlarged scale, illustrating the manner of inserting the separating fingers of FIG. 20 between adjacent filter pleats; and

FIGS. 22-24 illustrate another alternative embodiment of a disposable pleated filter media support frame in accordance with the present invention adapted for compact stacking with a collapsed pleated filter media for shipment and storage prior to assembly into an air filter.

### DETAILED DESCRIPTION OF THE INVENTION

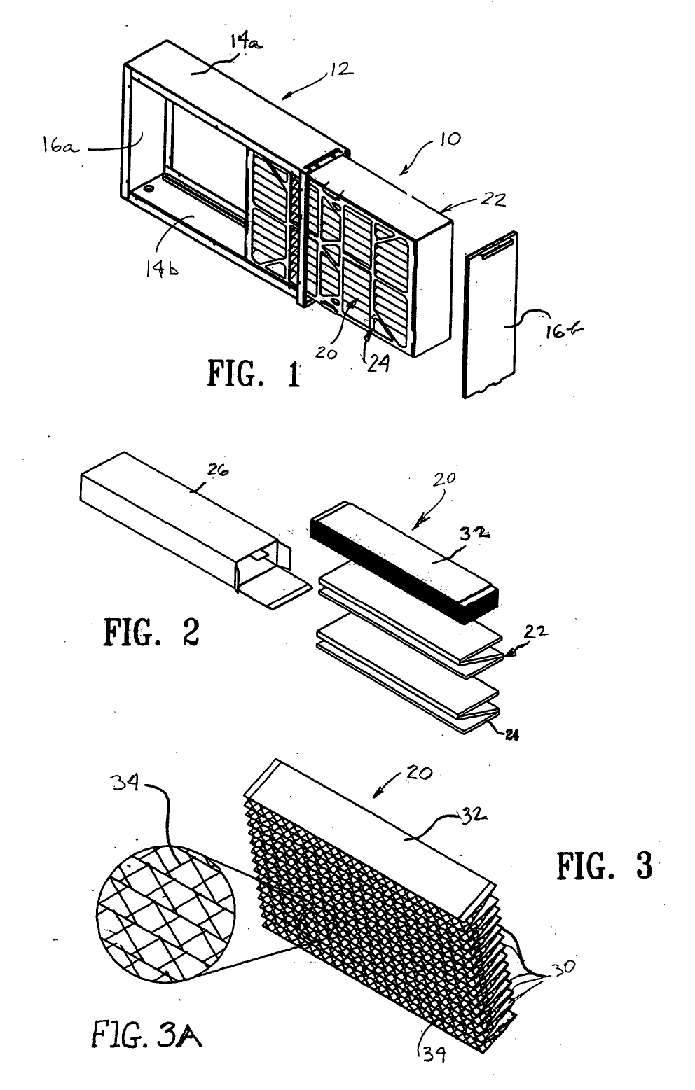

Referring now to the drawings, and in particular to FIGS. 1-11, a presently preferred embodiment of a disposable expandable air filter in accordance with the present invention is indicated generally at 10 in FIG. 1. The air filter 10 is adapted to be inserted into a conventional rectangular housing or frame cabinet having parallel upper and lower walls 14a and 14b, a closed end wall 16a, and a releasable opposite end wall 16b that is adapted to be attached to the housing or frame 12 so as to establish a rectangular air filter receiving housing or frame that has open sides to enable air to pass readily through the frame and an associated air filter 10 when inserted into the support housing, as is known. The air filter housing 12 is of the type normally placed in the airflow stream within a ducted residential forced-air type heating and cooling system (not shown). The housing 12 supports the replaceable air filter 10 so that air is drawn through the filter and unwanted particulate material is removed from the air by the filter. Periodic maintenance requires replacement of the air filter by sliding a dirty air filter from the housing or cabinet 12 and replacing it with a new clean filter.

Very generally, the disposable expandable air filter 10 is supplied in a compactly folded group of components that form a kit which when assembled includes a pleated air filter material that in its expanded condition defines an air filter media, indicated generally at 20, supported within a generally rectangular filter frame 22 on which is mounted a generally rectangular filter grill 24. The pleated filter 20, filter frame 22 and filter grill 24 are adapted to be folded compactly and stacked so as to enable insertion into a compact relatively small carton 26 for shipment and storage prior to reaching the ultimate consumer who can then remove the various components and assemble them into the air filter 10.

As illustrated in FIG. 3, the pleated filter media 20 includes pleated panels 30 of air filter material of conventional air filtering capability operative to capture particles of a predetermined size from air passing through the expanded pleated filter media. The filter material is folded alternately back upon itself in accordioned fashion with each panel 30 being of equal rectangular size and transverse width so that the pleated filter may be collapsed with juxtaposed panels of the pleated filter material in surface engaging relation, as shown in FIG. 2, and expanded to an operative filter condition as shown in FIG. 3. Preferably, a relatively rigid support plate, one of which is indicated at 32, is secured to the outer exposed surface of each of the opposite end panels 30 of the pleated filter and are of substantially equal rectangular area as the corresponding end panels. The support plates 32 may be made of a cardboard or other suitable lightweight material having desired rigidity characteristics to provide sturdy means for securing the end panels of the filter material into the filter frame 22, as will be described. Preferably, a metallic mesh support grid 34 is adhesively attached to the backside or downstream side of the pleated filter panels 30 to assist in preventing the pleats from collapsing under air pressure passing through the filter. The longitudinal lengths and transverse widths of the filter panels 30 are sized so that when the pleated filter is inserted within the filter frame 22 with the end plates 32 secured to selective panels of the filter frame, the opposite ends of the pleated filter panels engage the other two opposing panels of the filter frame so as to prevent air from bypassing the filter material as the air passes through the assembled filter.

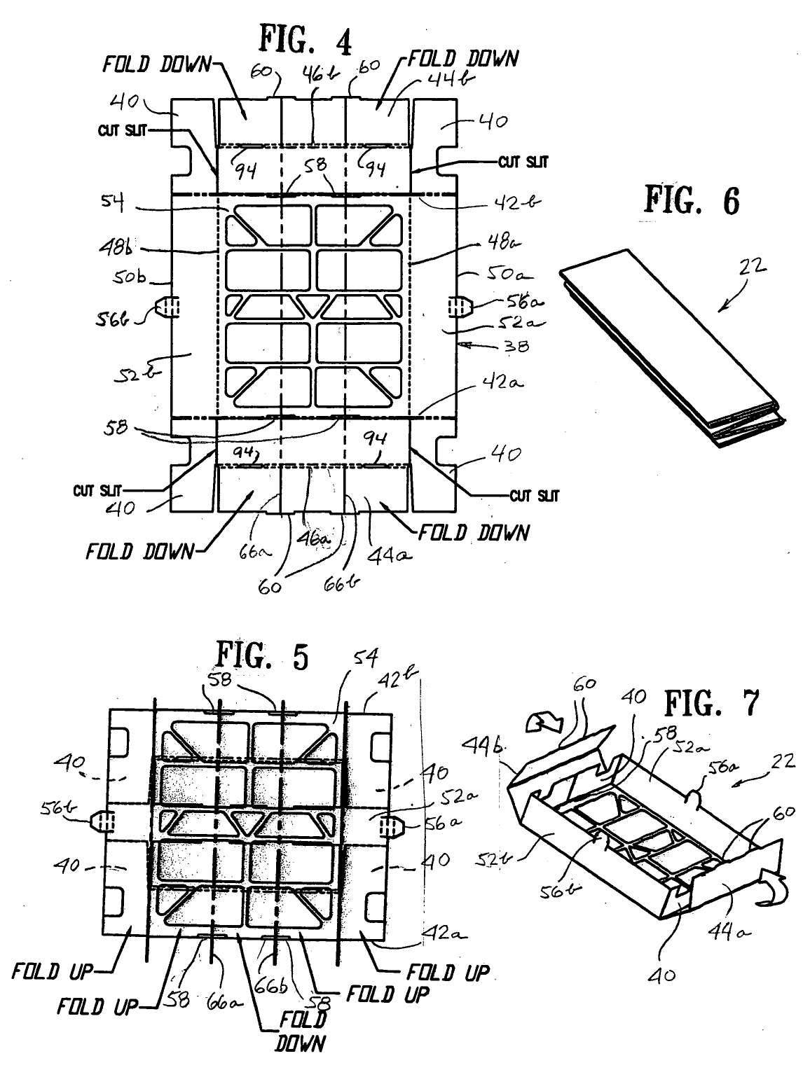

Referring now to FIGS. 4-7, the filter frame 22 is preferably made from a generally rectangular shaped blank of “beverage board” or small fluted corrugated cardboard as indicated generally at 38 in FIG. 4. The cardboard blank 38 is preferably lightweight but sufficient to provide the desired strength and rigidity for the assembled filter frame. As illustrated in FIG. 4, the blank 38 is pre-scored, slit, creased and die cut to form four corner panels 40 that are foldable about transverse fold line 42a and 42b. A pair of substantially identical end panels 44a and 44b are formed so as to be foldable about transverse fold lines 46a and 46b, respectively, and also about the transverse fold lines 42a and 42b so as to allow each end panel 44a and 44b to be folded upon itself with the corresponding corner panels 40 disposed between the folded portions of the end panels, as illustrated in FIG. 7. A pair of longitudinal fold lines 48a and 48b are formed parallel to outer longitudinal marginal edges 50a and 50b, respectively, of the blank 38 so as to establish side panels 52a and 52b when folded to positions normal to a rectangular central planar area 54 of the blank 38. A pair of foldable tabs 56a and 56b are formed, respectively, on the side panels 52a and 52b to facilitate attachment of the filter grill 24 as will be described. Slits or openings 58 are formed on the fold lines 42a and 42b to receive tabs 60 formed on the outer marginal edges of the end panels 44a and 44b when the blank 38 is folded into a rectangular frame structure as illustrated in FIG. 7. The rectangular central area 54 of blank 38 is formed with openings that enable substantially unimpeded airflow through the central area when the air filter is fully assembled.

As shown in FIG. 4, the blank 38 from which the filter frame is made is adapted to be folded about parallel fold lines 66a and 66b which are equidistantly spaced between the fold lines 48a,b. Before folding the blank 38 about the fold lines 48a,b and 66a,b, the corner panels 40 and end panels 44a and 44b are folded about their respective fold lines 42a and 42b so as to lie against the side panels 52a,b and center area 54, as illustrated in FIG. 5. The partially folded blank is then folded about the fold lines 48a,b and 66a,b to the compact position shown in FIG. 6 that has a rectangular size similar to the collapsed pleated air filter media 20 for insertion into the carton 26 with the collapsed filter media for shipment and storage preparatory to being assembled into the filter frame as illustrated in FIG. 7.

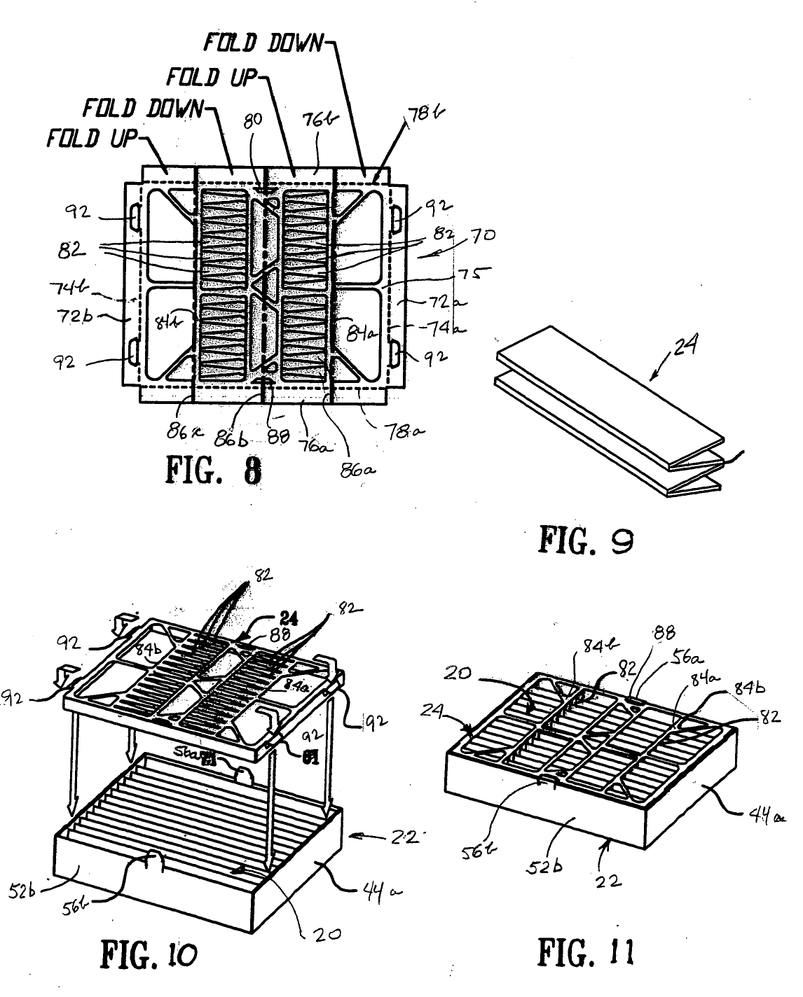

FIG. 8 illustrates a substantially rectangular blank of similar “beverage board” or small fluted corrugated cardboard, indicated generally at 70, from which the filter grill 24 is made. The blank 70 is also pre-scored, slit, creased and die cut to define end panels 72a and 72b that are foldable about fold lines 74a and 74b, respectively, to positions normal to a rectangular planar central area 75 of the blank. The blank 70 defines side panels 76a and 76b that are foldable about fold lines 78a and 78b, respectively, to positions normal to the central planar area 75.

The blank 70 also defines a pair of transverse rows of identical equally spaced locating and separating fingers 82 that are die cut from the blank and each has an enlarged end formed integral with a corresponding transverse support 84a or 84b. Each separating finger 82 is foldable about its connection to its corresponding support 84a,b and terminates in a free end having a partial circular curvature so as to prevent entanglement with the filter medium material when the separating fingers are interposed between adjacent pleats of the expanded filter 22, as will be described.

The blank 70 is foldable about three equidistantly spaced transverse fold lines 86a, 86b, and 86c into a compact rectangular folded condition of a size similar to the collapsed pleat filter media 20, as illustrated in FIG. 9, thereby facilitating stacked relation with the similarly folded filter frame 22 and the collapsed pleated filter 20 for insertion into the carton 26 as illustrated in FIG. 2.

Referring to FIGS. 10 and 11, with an expanded filter media 20 disposed within the filter frame 22 so that the support plates 32 on the filter end pleats are attached to inner surfaces of opposing filter frame sidewalls 52a and 52b, and with the end panels 72a,b and side panels 76a,b of the filter grill blank 70 folded to positions normal to the central planar area 75, the filter grill 24 is inserted into the filter frame so that the depending side and end panels of the grill are received inwardly of the upper margins of the filter frame wall panels 44a,b and 52a,b. With the filter grill thus inserted into the filter frame, the pleated filter support plates 32 are captured and sealed against the filter frame side panels 52a,b. Foldable tabs 56a,b on the filter frame are then inserted into slots 88 formed in the filter grill to retain the filter grill supported on the filter frame. Foldable tabs 92 formed on the filter grill blank 70 are also inserted into appropriately sized slot openings 94 formed in the end panels 44a and 44b of the filter frame blank 38 to assist in retaining the filter grill on the filter frame.

After mounting the filter grill 24 onto the filter frame 22 as described, the locating and separating fingers 82 are folded downwardly such that each separating finger is received between a pair of adjacent panels 30 of the expanded pleated filter 20. This ensures that the pleats are evenly spaced and are retained in their desired positions in the filter frame 22. The longitudinal lengths of the filter pleats are such that the free ends of the pleats engage the laterally opposite side panels 40a,b of the filter frame to prevent air flow from bypassing the filter media.

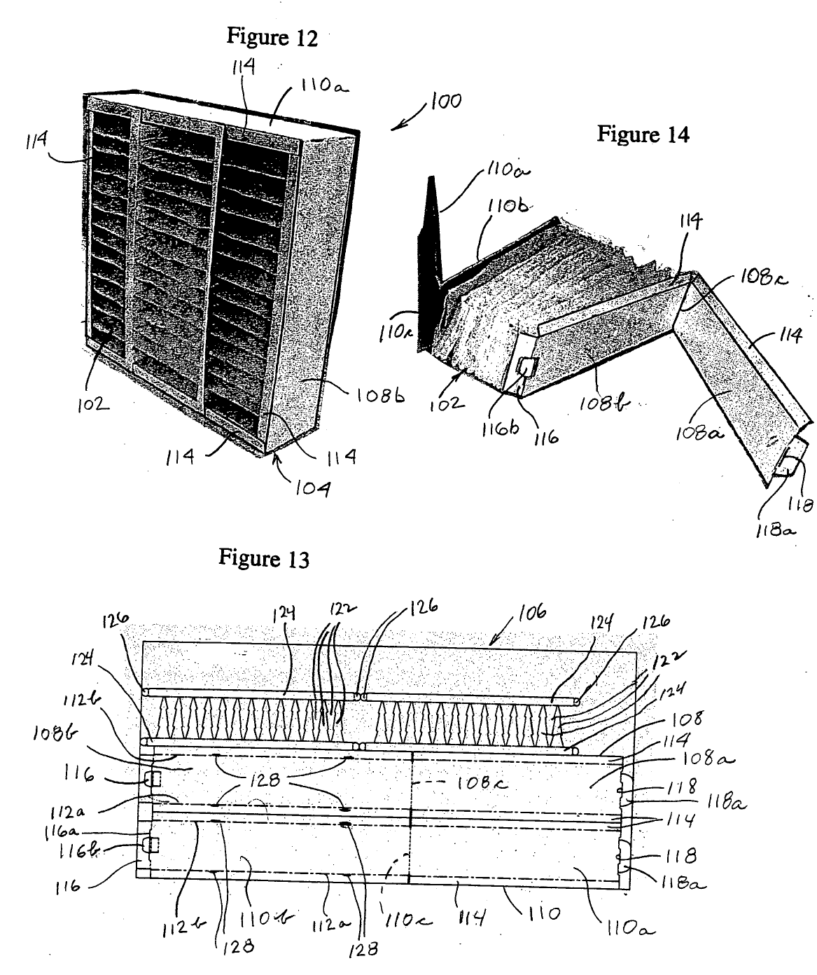

Referring now to FIGS. 12-21, a disposable expandable air filter constructed in accordance with an alternative embodiment of the present invention is indicated generally at 100 in FIG. 12. The air filter 100 includes an expandable pleated air filter media 102 made of conventional air filter materials similar to the pleated air filter media 20, and a rectangular filter frame 104 adapted to support the expanded air filter media 102. The filter frame is preferably made from a blank 106 of “beverage board” or lightweight corrugated cardboard as shown in FIG. 13. The filter frame 104 includes two identical primary cardboard frame components or members 108, 110 that are formed from the blank 106 by prescoring, slitting, creasing, and die cutting the cardboard blank. Each frame member 108, 110 includes a pair of generally rectangular panels 108a,b and 110a,b respectively, that are integrally interconnected at respective transverse fold lines 108c and 110c to establish panels of predetermined longitudinal length. Each frame member 108, 110 can be folded about its corresponding transverse fold line 108c, 110c so that the panels of each frame member are disposed at right angles to each other or disposed in substantially flat compact juxtaposed relation for insertion into a carton during shipping and storage before being formed into a rectangular filter frame.

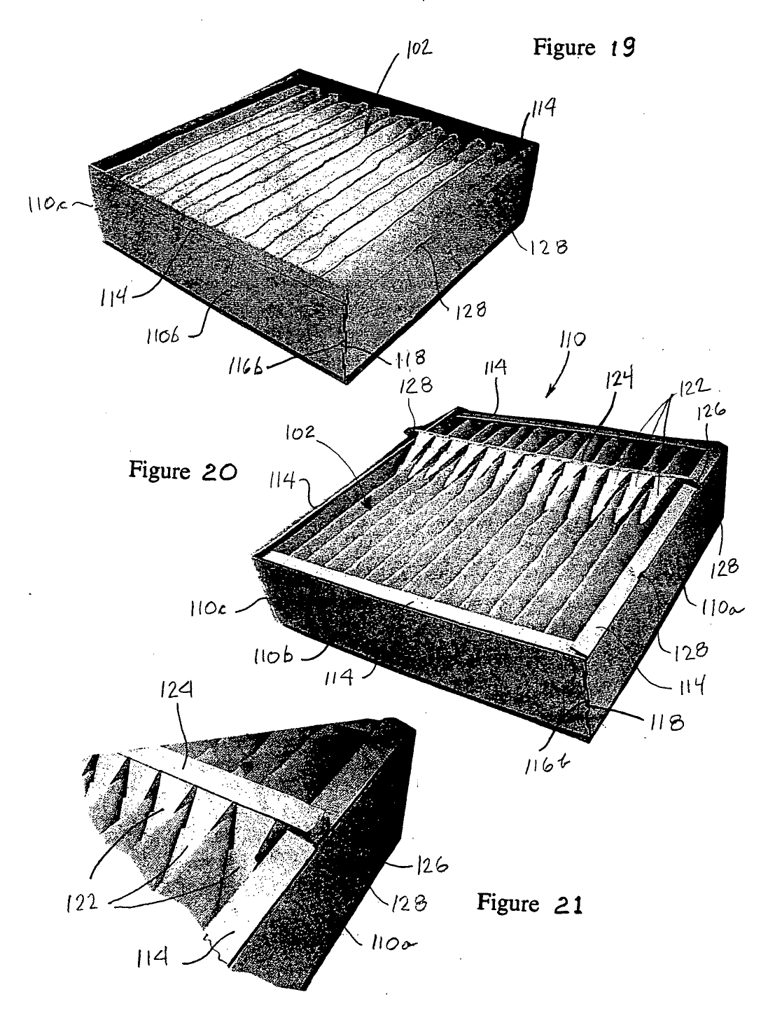

As shown in FIG. 13, each of the frame members 108, 110 has a pair of score lines or partial slits, as indicated at 112a,b, formed parallel to and inwardly from the parallel longitudinal marginal edges of the frame members. The score lines 112a,b define fold lines that enable the frame panels 108a,b and 110a,b to be formed into structural channel shapes of generally C-shaped transverse cross section with marginal portions 114 of the panels disposed substantially normal to the primary panels, thereby providing strength and rigidity for the rectangular filter frame in its final assembly. Each of the frame members 108 and 110 is formed with an end flap 116, a transverse through-slit 116a, and a tongue 116b at one end, and a slot 118 and foldable tab 118a at the opposite end that define a tongue and slot locking latch arrangement. With the panels 108a,b and 110a,b of each frame member folded to establish right angle corners, and positioned so that their free ends are mutually opposed, the flaps 116, tongues 116b, tabs 118a and slots 118 enable the frame members 108 and 110 to be interconnected to form a rectangular filter media support frame, as illustrated in FIGS. 18 and 19.

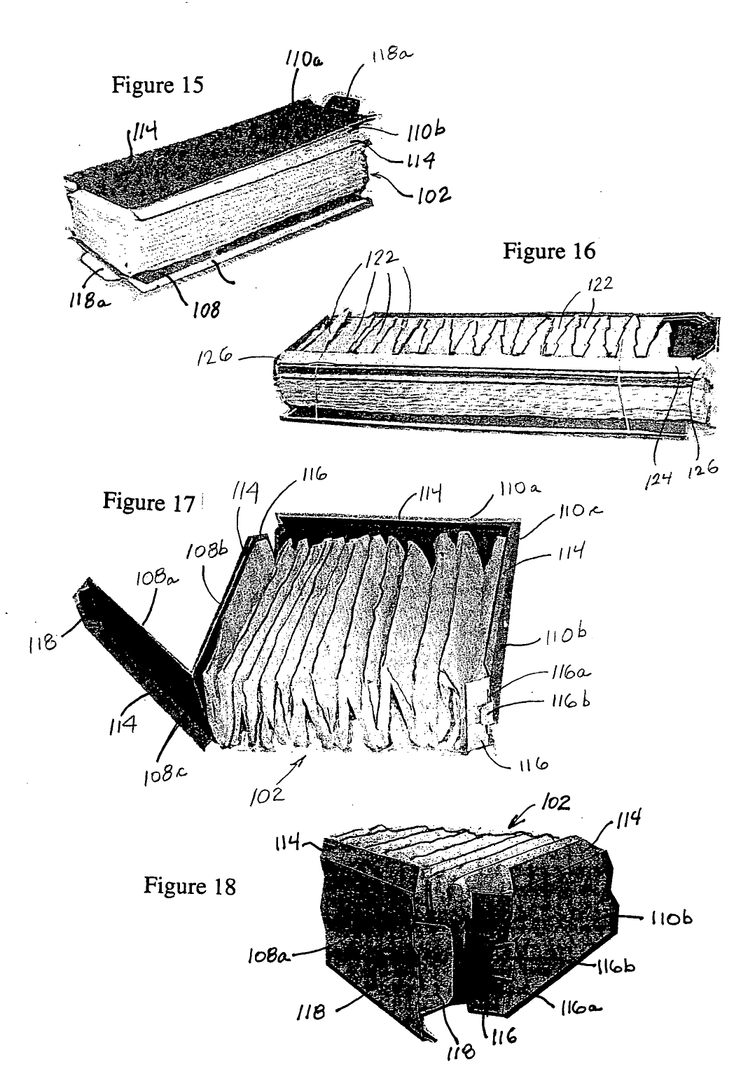

The panels 108a,b and 110a,b may be of equal or different longitudinal lengths to provide a rectangular filter frame 104. The pre-pleated filter media 102 is sized so that the outer exposed surfaces of the end panels or pleats are equal in size to a selected pair of the opposed panels 108a,b and 110a,b of the filter frame when assembled. The outer exposed surfaces of the end pleats may be attached to the selected opposite frame panels 108a or 108b and 110a or 110b by a suitable adhesive or mechanical fastener means such as staples or the like. With the panels 108a,b and 110a,b of the filter frame folded in juxtaposed relation, and with the outer end pleats of the filter media 102 secured to the selected frame panels, such as panels 108b and 110b as shown in FIGS. 14 and 17, the frame panels and pleated filter can be collapsed as shown in FIG. 15 preparatory to insertion into a carton for shipment and/or storage.

Referring again to FIG. 13, the blank 106 is die cut to form filter pleat separating means in the form of four rows or sets of separating fingers 122 for stabilizing the filter pleats in the final air filter assembly. As illustrated, the separating fingers 122 are generally V-shaped in plan configuration similar to the separating fingers 82. The separating finger 122 are die cut so that their wider ends are formed integral with corresponding header support pieces 124, with the separating fingers being foldable about their connections to their corresponding support pieces. The separating fingers 122 have longitudinal lengths that enable the four rows of separating fingers severed from the blank 106 to be placed on and bundled with the collapsed pleated filter media 102 and filter frame 104 for shipping and storage, as shown in FIG. 16. The opposite ends of the header support pieces 124 are formed with tongues 126 configured to enable insertion into and retention in slots 128 formed at the fold lines 112a,b on the frame members 108 and 110, as shown in FIGS. 20 and 21. In this manner, the rows of separating fingers 122 can be secured to opposite sides of the filter frame and the separating fingers folded inwardly into and between adjacent pleats in the expanded filter media 102. The marginal edges of the generally V-shaped separating fingers may be formed in a notched or stepped pattern so that the fingers interact with the filter media material to retain the fingers between adjacent pleats.

As noted, air filter 100 is adapted to be shipped to customers in a “collapsed state”. The accordioned filter media 100 is sandwiched between the flattened primary frame members 108 and 110 with the separating fingers 122 supplied also in a flat state and laid upon the frame members as shown in FIG. 16. The assembly of the collapsed air filter for installation into an air cleaner system begins with expanding the accordioned pre-pleated filter material and unfolding a leg or panel of each filter frame members 108, 110 as shown in FIGS. 14 and 17. The mutually opposed free ends of the frame members are secured together with the integrated locking latch arrangement that includes end flap 116, tongue 116a, slot 118 and tab 118a, as shown in FIGS. 13, 14 and 17-19. The edges or marginal flaps 114 of the frame members are folded inwardly to form a continuous channel shape around the filter frame that provides strength and stability to the filter frame structure. The header supports 124 and separating fingers 122 are attached to the front and rear of the filter frame with the tongue 126 and slot 128 arrangement as shown in FIGS. 20 and 21. This attachment stabilizes the channel folds 114 and supports the separating fingers 122. The separating fingers 122 are folded individually into the spaces between each filter media pleat to assure that the pleats are evenly spaced and are retained in desired positions. The separating fingers 122 also secure the expanded filter medial material inside the filter frame and assure that the opposite free ends of the filter pleats are sealed against the inside surfaces of the opposing frame member panels to prevent air bypass.

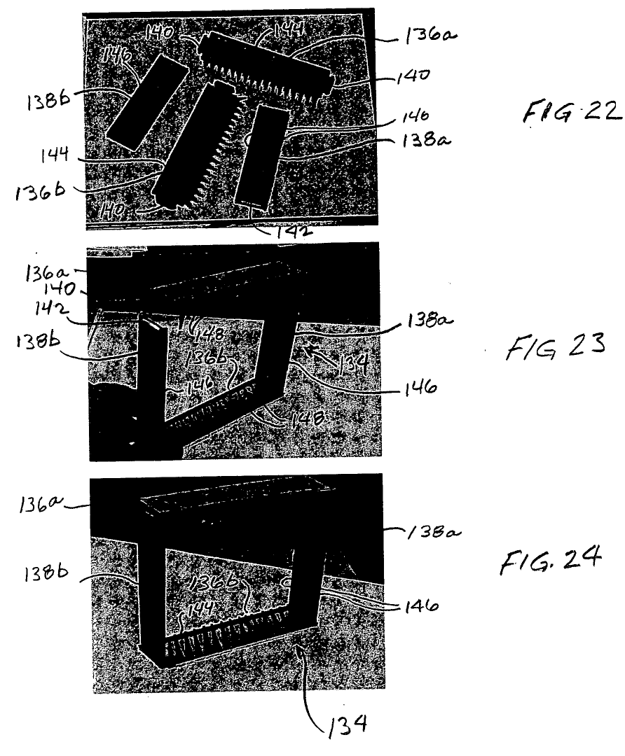

FIGS. 22-24 illustrate another alternative embodiment of a disposable collapsible filter frame, indicated generally at 134, constructed in accordance with the present invention. The filter frame 134 differs from the filter frame 104 illustrated in FIGS. 14 and 17-19 in that the filter frame 134 is formed from two pairs of separate elongated generally rectangular frame members indicated at 136a,b and 138a,b. The pairs of frame members 136a,b and 138a,b are adapted to be stacked and secured in juxtaposed relation with a collapsed pleated media filter, such as 20 or 102, preferably interposed between the frame members. The four frame members 136a,b and 138a,b are preferably die cut from a blank of corrugated cardboard similar to the blank 106 and are of a rectangular size similar to the rectangular filter media pleats to enable compact stacking with the collapsed pleated filter media.

The frame members of each pair 136a,b and 138a,b are of equal longitudinal length, but the length of each pair may differ from the other pair so as to create a rectangular filter frame of desired size. The pairs of frame members 136a,b and 138a,b are adapted to have their opposite ends interconnected by connecting tabs or flaps 140 formed on opposite ends of frame member 136a,b, and tab receiving slots 142 formed on opposite ends of frame members 138a,b so as to create a rectangular filter support frame. Each of the four frame members 136a,b and 138a,b also has longitudinal flanges 144 and 146, respectively, formed at their marginal edges that enable the frame members to be formed into generally C-shape or channel shape to provide strength and rigidity to the frame and support an expanded pleated filter such as 102.

Filter pleat separating fingers 148 similar to the separating fingers 122 are formed integral with at least one of the longitudinal flanges 144 on each of the frame members 136a,b or on at least one of the longitudinal flanges 146 on frame members 138a,b depending on the desired orientation of an expanded pleated filter media when supported within the assembled filter frame members. The rows of separating fingers 148 are formed on the frame members 136a,b so as to be laterally opposed in the assembled filter frame 134, and can be folded inwardly between the pleats of an expanded pleated filter when supported within the filter frame.

Thus, in accordance with the present invention, various embodiments of a totally disposable expandable air filter are disclosed that enable the various components to be compactly stacked and secured for insertion into a carton for shipping and storage until assembled. The various filter frame components may be formed from pre-scored, slit, creased and die cut corrugated cardboard blanks and are adapted to be assembled into a rectangular generally open-center frame that receives and supports a collapsible pleated filter media when in its expanded condition. Integral or separate separating fingers are formed from the cardboard blank and enable insertion between adjacent filter pleats to maintain the pleats in relatively fixed relation yet do not inhibit stacking and storage of the air filter components as a compact air filter kit.

While various embodiments of the invention have been illustrated and described, it will be understood to those skilled in the art that changes and modifications may be made therein without departing from the invention in its broader aspects. Various features of the invention are defined in the following claims.

What is claimed is:

1. A disposable air filter comprising;
a filter frame and a pleated air filter media, said pleated air filter media having generally rectangular interconnected panels collapsible so that adjacent panels are disposed in juxtaposed relation,
said filter frame being made from a generally planar blank that is pre-scored, slit and die-cut to define a rectangular filter frame having a central area enabling airflow therethrough and having laterally opposite longitudinal and transverse wall panels foldable to positions normal to said central area and defining a peripheral wall about said central area sized to receive and support the pleated filter media when in an expanded condition so that substantially all air passing into said central area passes through said filter media,
said filter frame blank being foldable to a substantially flat condition having a rectangular size generally equal to the rectangular size of the collapsed filter media panels so as to enable compact stacking with said collapsed filter media and insertion into a carton.

2. A disposable air filter as defined in claim 1 wherein said filter frame longitudinal and transverse wall panels have means on opposite ends thereof enabling said wall panels to be interconnected to form a rectangular air filter frame, said filter frame wall panels having planar panel portions and laterally opposite longitudinal marginal edge portions foldable to positions normal to said planar panel portions so as to define wall panels having channel-shaped transverse cross-sections to receive and retain said expanded pleated filter media.

3. A disposable air filter as defined in claim 2 wherein said filter frame blank further defines a plurality of separating fingers disposed in a row and adapted to be attached to said filter frame for insertion between adjacent pleats of said pleated filter media when in its expanded condition within said filter frame.

4. A disposable air filter as defined in claim 3 wherein said filter frame blank defines a plurality of rows of said separating fingers, each of said rows being adapted for attachment to said filter frame transverse to the pleats of the filter media when disposed in said filter frame.

5. A disposable air filter as defined in claim 2 wherein at least one of filter frame wall panels has a plurality of separating fingers formed thereon in a manner to enable insertion of said fingers between adjacent pleats of a pleated filter media when supported by said rectangular filter frame.

6. A disposable air filter as defined in claim 1 including a filter grill made from a blank that is pre-scored, slit and die-cut to define laterally opposite pairs of side and end panels formed integral with a generally open central area, said side and end panels being foldable to positions substantially normal to said central area and adapted to be received internally of free marginal edges of said filter frame with said central areas generally parallel, said filter grill and filter frame having mutually cooperable means for retaining them in assembled relation with an expanded pleated filter media disposed between said filter frame and filter grill.

7. A disposable air filter as defined in claim 6 wherein said filter grill includes at least one row of substantially equally spaced separating fingers adapted to be inserted between adjacent pleats in an expanded pleated filter media when disposed between said filter grill and filter frame.

8. A disposable air filter as defined in claim 6 wherein said filter frame and filter grill blanks are made from a lightweight corrugated cardboard.

9. A disposable air filter as defined in claim 2 wherein said means on the opposite ends of said wall panels enabling said panels to be interconnected to form a rectangular air filter frame include mutually cooperable slots and tabs.

10. A disposable air filter as defined in claim 1 including an end plate secured in juxtaposed relation to an outer exposed surface of each end panel of said filter media, said end plates being substantially equal in size to the exposed surface area of the corresponding filter media end panel.

11. A disposable air filter as defined in claim 1 wherein said filter frame central area has substantially greater air flow open area than a remaining non-open area of said central area.

12. A disposable air filter as defined in claim 10 wherein said rectangular filter media panels have greater longitudinal length than transverse width, said filter element pleats having greater longitudinal length than the distance between said filter frame wall panels adjacent the ends of said filter element pleats when disposed within said filter frame with the longitudinal lengths of said filter panels substantially normal to said adjacent filter frame wall panels so as to prevent air passage between the ends of said filter panels and said adjacent filter frame wall panels.

13. A disposable air filter as defined in claim 10 wherein said end plates are made from a rigid material.

14. A disposable air filter as defined in claim 13 wherein said rigid material comprises a rigid cardboard.

15. A disposable air filter assembly as defined in claim 1 wherein said pleated filter media has opposite side surfaces, and including a metallic mesh support grid adhesively secured to a selected one of said side surfaces of said pleated filter media.

16. A disposable air filter assembly as defined in claim 1 including means secured to a selected side surface of said pleated filter element for preventing collapse of said panels during passage of air through the filter assembly.

17. A disposable air filter assembly as defined in claim 7 wherein said separating fingers are sufficient in number so that a finger extends into each space defined between adjacent pleats of said pleated filter media when expanded.

18. A disposable air filter assembly as defined in claim 7 wherein said separating fingers are formed integral with said filter grill blank so as to define at least two transverse rows of said separating fingers.

19. A disposable air filter assembly as defined in claim 18 wherein said separating fingers in each of said transverse rows have free ends extending in a direction toward the free ends of the fingers in the other row of separating fingers.

20. A method of making a disposable air filter kit comprising the steps of:
providing an expandable pleated filter media having a plurality of generally equal size rectangular filter panels with end plates affixed to outer exposed surfaces of the opposite end panels;
providing a filter frame including a plurality of frame member panels adapted to be stacked in juxtaposed relation with said pleated filter media when in a collapsed condition, said frame member panels having means disposed on free ends thereof for enabling interconnection of said panels to create a rectangular filter frame sized to receive said pleated filter media into said filter frame when expanded so that opposite free end edges on said filter panels engage selected frame member panels to prevent air passage past the free ends of said filter panels; and
providing a plurality of separating fingers adapted to be compactly stacked with said frame members and collapsed pleated filter media into a kit and being cooperative with said frame member panels to enable insertion of said fingers into openings created between adjacent pleats in the expanded filter media to maintain the pleats in stable positions in the assembled air filter.

21. A disposable air filter assembly comprising, in combination,
an expandable pleated air filter element having a plurality of interconnected panels of generally equal longitudinal length and transverse width;
a filter frame made from a generally rectangular corrugated cardboard blank defining a generally planar rectangular central area enabling air passage therethrough, said blank defining laterally opposite longitudinal side panels and transverse end panels disposed coplanar with said central area and being foldable about respective substantially longitudinal and transverse fold lines to positions generally normal to said central panel and positions in juxtaposed relation to said central area, said side and end panels being mutually cooperable when in said positions normal to said central area to form a perimeter wall about and normal to said central area for receiving said filter element in its expanded condition, said filter frame blank being foldable into a compact generally flat rectangular condition having a longitudinal length and transverse width generally similar to the longitudinal length and transverse width of said filter element panels, and
a filter grill mountable on said filter frame, said filter grill being made from a generally rectangular corrugated cardboard blank defining a generally rectangular planar central area of a size and configuration substantially equal to the size and configuration of said filter frame central area and enabling air to pass therethrough, said filter grill blank further defining laterally opposite longitudinally extending marginal side wall panels and laterally opposite transverse marginal end wall panels foldable from positions coplanar with said central area to positions disposed normal to said central area for mutual cooperation to establish a boundary wall about the periphery of said filter grill central area, said filter grill central area and side wall and end wall panels being foldable into a compact generally flat rectangular condition having a longitudinal length and transverse width generally similar to the longitudinal length and transverse width of said collapsed filter element panels, said filter element, filter frame blank and filter grill blank being foldable into generally flat rectangular compact positions and stackable in juxtaposed relation for insertion into a carton.

22. A disposable air filter assembly as defined in claim 21 including a carton having a generally rectangular transverse cross section sized to enable insertion of said filter element, filter frame and filter grill when in their compact flat folded positions and stacked in juxtaposed relation.

23. A disposable air filter assembly as defined in claim 21 wherein said pleated filter element has opposite side surfaces, and including a metallic mesh support grid adhesively secured to a selected one of said side surfaces of said pleated filter.

24. A disposable air filter assembly as defined in claim 21 wherein said filter grill blank defines a plurality of pleat separating fingers formed integral with said filter grill and adapted to be interposed between adjacent pleats of the filter element when said filter grill is mounted on said filter frame and said filter element is disposed in an expanded condition within said filter frame.

25. A disposable air filter assembly as defined in claim 24 wherein said separating fingers are sufficient in number so that a separating finger extends into each space between adjacent pleats of said expanded pleated filter element.

26. A disposable air filter assembly as defined in claim 24 wherein said separating fingers are formed integral with said central area of said filter grill so as to define at least two transverse rows of said separating fingers.

27. A disposable air filter assembly as defined in claim 26 wherein said separating fingers in each of said transverse rows have free ends extending in a direction toward the free ends of the separating fingers in the other row of separating fingers.

28. A disposable air filter as defined in claim 21 including a generally rigid end plate secured in juxtaposed relation to an outer exposed surface of each pleated filter end panel.

29. A method of making a disposable air filter comprising the steps of:
providing an expandable pleated filter element having a plurality of generally equal size rectangular filter panels with adjacent panels being interconnected at mutually opposed longitudinal edges and having generally rigid end plates affixed to outer exposed surfaces of end panels;
providing a filter frame having a generally planar central area and laterally opposed pairs of sidewalls disposed in normal relation to said central area and having mutually interconnected ends so as to establish a continuous wall peripherally of said central area, said central area having one or more openings enabling air to pass therethrough;
inserting said filter element into said filter frame when expanded so that opposite marginal end edges on said filter panels engage said continuous wall to prevent air passage past the ends of said filter panels;
providing a filter grill having a planar central area and a peripheral wall disposed normal to said central area, said filter grill being sized to enable said peripheral wall of said filter grill to be disposed in juxtaposed relation to the peripheral wall of the base surface with the filter element interposed between the central areas of said filter frame and filter grill, said filter grill having a plurality of separating fingers formed integral therewith for insertion between adjacent pleats of the expanded filter element;
attaching the filter grill to the filter frame; and
inserting said separating fingers between pleats of said expanded filter element.
